(19) United States
(12) Patent Application Publication
(10) Pub. No.: US 2013/0045728 A1
(43) Pub. Date: Feb. 21, 2013

(54) System And Method For Receiving And Placing Telephone Calls

(71) Applicant: Belkin International Inc., Playa Vista, CA (US)

(72) Inventors: Kent Iverson, Hermosa Beach, CA (US); Mack Ray McCoy, Irvine, CA (US); Hyeun Suk Mun, Torrance, CA (US); Megan McAtee, San Diego, CA (US); Raffaele Mazzei, San Diego, CA (US); Oliver Duncan Seil, Pasadena, CA (US); Ryan Yun Kim, Torrance, CA (US); John M. Norton, Santa Clarita, CA (US); Brian L. Van Harlingen, Torrance, CA (US)

(73) Assignee: BELKIN INTERNATIONAL INC., Playa Vista, CA (US)

(21) Appl. No.: 13/657,695

(22) Filed: Oct. 22, 2012

Related U.S. Application Data
(63) Continuation of application No. PCT/US2011/033676, filed on Apr. 22, 2011.
(60) Provisional application No. 61/327,092, filed on Apr. 22, 2010.
(60) Provisional application No. 61/334,174, filed on May 12, 2010.

(51) Int. Cl. H04W 4/16

(52) U.S. Cl. 455/417

(57) ABSTRACT

In some embodiments, a method of placing and receiving a telephone call can include: determining that a mobile device has been coupled to a docking station while communicating audio for the telephone call using the mobile device and a wireless telephone network; communicating to a server that the mobile device has been coupled to the docking station; requesting that the server facilitate transfer of the telephone call from the wireless telephone network to a wired network; receiving incoming audio for the telephone call using the docking station and the wired network; and sending outgoing audio for the telephone call using the docking station and the wired network. The audio for the telephone call can include the incoming audio and the outgoing audio. Other embodiments are disclosed.

### CROSS-REFERENCE TO RELATED APPLICATIONS

This application claims the benefit of U.S. Provisional Application No. 61/327,092, filed Apr. 22, 2010, U.S. Provisional Application No. 61/334,174, filed May 12, 2010 and International Application Number PCT/US11/33676, filed Apr. 22, 2011. U.S. Provisional Application No. 61/327,092, U.S. Provisional Application No. 60/334,174 and International Application Number PCT/US11/33676 are incorporated herein by reference.

### FIELD OF THE INVENTION

This invention relates generally to methods and systems for placing and receiving telephone calls, and relates more particularly to such methods and systems for placing and receiving telephone calls using wired networks and wireless telephone networks.

### DESCRIPTION OF THE BACKGROUND

Many people have a mobile device that can be used to make telephone calls using a wireless telephone network, and these same people also have one or more telephones connected to a wired network (i.e., a landline telephone). Typically, the landline telephones are located in people's home or office. Having two or more telephones presents several challenges and frustrations to most people. For example, if a person receives a telephone call on his landline office telephone when he is ready to leave his office, he cannot easily transfer the telephone call from his landline office telephone to his mobile device. In another example, a person can be talking on his mobile device and enter her home where she has a landline telephone. This person may pay by the minute for telephone calls on her mobile device and the pay a flat monthly fee for her home's landline telephone service. Thus, the person may want to transfer the telephone call to her home's landline telephone to save some money.

Using existing mobile devices and landline telephones to switch a telephone call between a mobile device and a landline telephone, the user will have to hang-up his current call on his first telephone, and then call the other person back on the second telephone to switch the telephone call from the wireless telephone network to the wired network, or vice-versa. This method of switching the telephone call is inefficient and inconvenient. Accordingly, a need or potential for benefit exists for a method or system that allows a person to easily switch telephone calls between wireless telephone networks and wired networks.

### BRIEF DESCRIPTION OF THE DRAWINGS

To facilitate further description of the embodiments, the following drawings are provided in which:

FIG. 1 illustrates a top, left side, front isometric view of a docking station and mobile device of a system for placing and receiving telephone calls, according to a first embodiment;

FIG. 2 illustrates a block diagram of the system of FIG. 1 for placing and receiving telephone calls, according to the first embodiment;

FIG. 3 illustrates a top, left side, front isometric view of a docking station and the mobile device of FIG. 1, according to a second embodiment;

FIG. 4 illustrates a top, left side isometric view of a docking station and the mobile device of FIG. 1, according to a third embodiment;

FIG. 5 illustrates a top, left side isometric view of docking station and the mobile device of FIG. 1, according to a fourth embodiment;

FIG. 6 illustrates a block diagram of a system for placing and receiving telephone calls, according to the fifth embodiment;

FIG. 7 illustrates a flow chart for an exemplary embodiment of a method of placing and receiving telephone calls;

FIG. 8 illustrates a flow chart for an exemplary embodiment of an activity of communicating to a server that the mobile device has been coupled to the docking station;

FIG. 9 illustrates a flow chart for another exemplary embodiment of a method of placing and receiving telephone calls;

FIG. 10 illustrates a flow chart for an exemplary embodiment of an activity of communicate to the server that a user wants to uncouple the mobile device from the docking station;

FIG. 11 illustrates a computer that is suitable for implementing an embodiment of the server of FIG. 2; and

FIG. 12 illustrates a representative block diagram of an example of the elements included in the circuit boards inside chassis of the computer of FIG. 11.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

In some embodiments, a method of placing and receiving a telephone call can include: determining that a mobile device has been coupled to a docking station while audio for the telephone call is communicated using the mobile device and a wireless telephone network; communicating to a server that the mobile device has been coupled to the docking station; requesting that the server facilitate transfer of the telephone call from the wireless telephone network to a wired network; receiving incoming audio for the telephone call using the docking station and the wired network; and sending outgoing audio for the telephone call using the docking station and the wired network. The audio for the telephone call can include the incoming audio and the outgoing audio.

In the same or different embodiments, a system for placing and receiving a telephone call can include a docking station configured to couple to a mobile device. The docking station can include: (a) at least one processor; (b) an electrical connector configured to couple to the mobile device; (c) a switch configured to couple to a wired network; (d) one or more input mechanisms configured to receive input from a user; (e) one or more visual indications configured to provide information to the user; (f) a docking station module configured run on the at least one processor. The docking station module can include: (a) a wired network module configured to communicate data for the telephone call over the wired network; and (b) a transfer module configured to transfer the telephone call from a wireless telephone network to the wired network when the mobile device is coupled to the electrical connector of the docking station.

In other embodiments, a method of placing and receiving a telephone call can include: receiving incoming audio for the telephone call using a wired network and a docking station when a mobile device is coupled to the docking station; sending outgoing audio for the telephone call using the wired network and the docking station when the mobile device is coupled to the docking station; receiving an indication that a user desires to uncouple the mobile device from the docking station; communicating to a server to switch the telephone call from the wired network to a wireless telephone network; receiving the incoming audio for the telephone call in the mobile device using the wireless telephone network; sending the outgoing audio for the telephone call in the mobile device using the wireless telephone network; ending receiving the incoming audio and sending the outgoing audio for the telephone call via the wired network and the docking station; and indicating to the user that the mobile device can be uncoupled from the docking station.

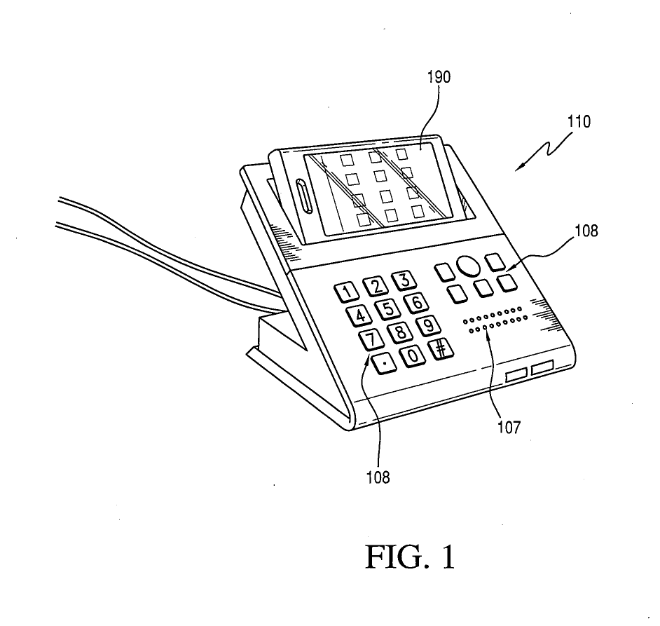

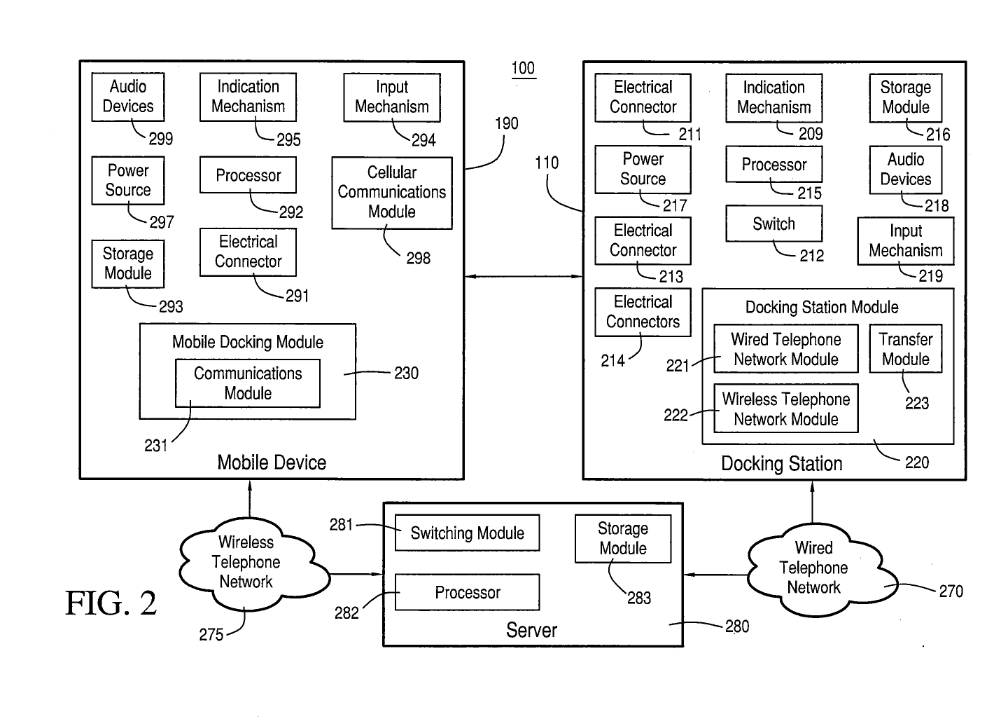

Turning to the drawings, FIG. 1 illustrates a top, left side, front isometric view of a docking station 110 and a mobile device 190 of a system 100 for placing and receiving telephone calls, according to a first embodiment. FIG. 2 illustrates a block diagram of system 100, according to the first embodiment. System 100 is merely exemplary and is not limited to the embodiments presented herein. System 100 can be employed in many different embodiments or examples not specifically depicted or described herein.

In some embodiments, system 100 for placing and receiving telephone calls can include: (a) docking station 110; (b) mobile device 190; and (c) server 280 in communication with docking station 110 and mobile device 190 using wired network 270 and wireless telephone network 275, respectively. In different embodiments, system 100 can include docking station 110 and one or more software modules (e.g., mobile docking module 230 on mobile device 190), and does not include mobile device 190. In these embodiments, system 100 can include or not include server 280.

Not to be taken in a limiting sense, a simple example of using system 100 for receiving a telephone call involves a user receiving (or initiating) a telephone call using mobile device 190. While the user is participating in the telephone call, the user couples mobile device 190 to docking station 110. When the mobile device 190 is coupled to docking station 110, system 100 can switch the audio of the telephone call from audio devices 299 (e.g., a speaker and a microphone) of mobile device 190 to audio devices 218 (e.g., a speaker and a microphone, a telephone handset, and/or telephone headset) of docking station 110. That is, audio devices 218 can be used to send and receive the audio for the telephone call and can replace audio devices 299.

In addition, docking station 110 (and/or mobile device 190) can recognize that mobile device 190 has been coupled to docking station 110 and begin the process of transferring the telephone call without interruption of the telephone call from wireless telephone network 275 to wired network 270. That is, system 100 can transfer the telephone call such that the telephone call is no longer being received by mobile device 190 using wireless telephone network 275. Instead, the telephone call is now being received by docking station 110 using wired network 270.

In some examples, when mobile device 190 is coupled to docking station 110, docking station module 220 of docking station 110 can communicate to switching module 281 of server 280 that the mobile device 190 is coupled to docking station 110 and request that the telephone call be transferred from wireless telephone network 275 to wired network 270. After receiving the request, switching module 281 can facilitate the data for the telephone call to be communicated to docking station 110 via wired network 270 while continuing to send the data for the telephone call to mobile device 190 via wireless telephone network 275. In one embodiment, when the data for the telephone call is communicated to docking station 110 from wired network 270, docking station 110 can communicate the data for the telephone call to mobile device 910 while mobile device 190 is coupled to docking station 110. In this embodiment, mobile device 910 can receive the data for the telephone call from wireless telephone network 275 and from wired network 270. In a different embodiment, while the data for the telephone call is communicated to docking station 180 from wired network 270, mobile device 190 can communicate the data for the telephone call to docking station 110 while mobile device 190 is coupled to docking station 110. In this different embodiment, docking station 110 can receive the data for the telephone call from wireless telephone network 275 and from wired network 270.

After docking station 110 receives the data for the telephone call from server 280 via wired network 270, docking station module 220 can communicate to mobile device 190 to end the telephone call over wireless telephone network 275, or mobile device 190 can end the telephone call over wireless telephone network 275 by itself. At this point, the telephone call has been successfully transferred from wireless telephone network 275 to wired network 270.

Similarly, a telephone call can be transferred from wired network 270 to wireless telephone network 275 (i.e., the user can undock mobile device 190 from docking station 110). For example, after a user initiates a telephone call from docking station 110, the user can press an input mechanism (e.g., input mechanisms 219 of docking station 110 or input mechanisms 294 of mobile device 190) to indicate the user's desire to uncouple mobile device 190 from docking station 110. Docking station module 220 can communicate to switching module 281 that the user wants to uncouple mobile device 190 from docking station 110 and request that the telephone call be transferred to wireless telephone network 275 from wired network 270. After receiving the request, switching module 281 can arrange for the data for the telephone call to be communicated to mobile device 190 via wireless telephone network 275 while continuing to send the data for the telephone call to docking station 110 via wired network 270. In one embodiment, while the data for the telephone call is communicated to mobile device 190 from wireless telephone network 275, mobile device 190 can communicate the data for the telephone call to docking station 110 while mobile device 190 is coupled to docking station 110. In this embodiment, docking station 110 can receive the data for the telephone call from wireless telephone network 275 and from wired network 270. In a different embodiment, while the data for the telephone call is communicated to mobile device 190 from wireless telephone network 275, docking station 110 can communicate the data for the telephone call to mobile device 190 while mobile device 190 is coupled to docking station 110. In this different embodiment, mobile device 190 can receive the data for the telephone call from wireless telephone network 275 and from wired network 270.

After mobile device 190 receives the data for the telephone call via wireless telephone network 275, docking station module 220 or mobile device 190 can communicate to switching module 281 to stop sending the data from the telephone call via wired network 270. Then, server 280 can stop sending the data for the telephone call via wired network 270 and only send the data for the telephone call via wireless telephone network 275.

Next, the user can be notified that it is safe to uncouple mobile device 190 from docking station 110 using an indication mechanism (e.g., indication mechanism 209 of docking station 110 or indication mechanism 295 of mobile device 190). At this point, the telephone call has been successfully transferred from wired network 270 to wireless telephone network 275.

In some embodiments, wired network 270 can be IP (internet protocol) network (e.g., the Internet) or an IP network in combination or communication with other types telephone networks. For example, wired network 270 can be a digital IP data network that carries telephony traffic. In other embodiments, wired network 270 can be a non-IP network.

Docking station 110 can be configured to couple to mobile device 190 and can include: (a) an electrical connector 211 configured to couple to an electrical connector 291 of mobile device 290; (b) at least one switch 212 configured to communicate with wired network 270; (c) at least one electrical connector 213 coupled to switch 212 and configured to couple to wired network 270; (d) at least one electrical connector 214 coupled to switch 212 and configured to couple one or more other electrical devices to wired network 270 (via switch 212 and electrical connector 213); (e) at least one processor 215; (f) a storage module 216; (g) one or more audio devices 218; (h) one or more input mechanisms 219 (e.g., a touch screen and/or one or more buttons) configured to receive input from a user of system 100; (i) docking station module 220 configured to run on processor 215 and be stored in storage module 216; (j) indication mechanism 209; and (j) a power source 217 configured to provide electrical power for electrical connectors 211, 213, 214, switch 212, processor 215, storage module 216, audio devices 218, indication mechanism 209, and/or input mechanisms 219.

Mobile device 190 can be configured to couple to docking station 110 and can include: (a) an electrical connector 291 configured to couple to electrical connector 211; (b) at least one processor 292; (c) a storage module 293; (d) at least one input mechanism 294 (e.g., a touch screen and/or one or more buttons); (e) at least one indication mechanism 295 (e.g., a video screen integrated into a touch screen and/or at least one LED (light emitting diode)); (f) mobile docking module 230 configured to run on processor 292 and be stored in storage module 293; (g) a cellular communications module 298 configured to communicate with wireless telephone network 275; (h) one or more audio devices 299 (e.g., a speaker and microphone and/or one or more audio connectors); and (i) a power source 297 configured to provide electrical power for electrical connectors 291, processor 292, storage module 293, input mechanisms 294, indication mechanisms 295 and/or audio devices 299.

Mobile docking module 230 can include a communication module 231 configured to communicate with docking station module 220 and cellular communications module 298. Communication module 231 can be configured to facilitate beginning and ending of connections using wireless telephone network 275.

In some embodiments, mobile device 190 can be an electrical device that includes cellular (or mobile) phone capabilities. For example, mobile device 190 can be: (a) a smart device running the Android operating system developed by the Open Handset Alliance; (b) a smart device manufactured by Research in Motion Limited (e.g., the Blackberry® device); (c) a smart device manufactured by Palm, Inc. (e.g., the Palm® device); or (d) a smart device manufactured by Apple Computer, Inc. (e.g., the iPad® device, and/or the iPhone® device).

In some embodiments, server 280 can communicate to mobile device 190 via wireless telephone network 275 and can communicate to docking station 110 via wired network 270. In the same or different embodiment, server 280 can also communicate to mobile device 190 via the wired network and docking station 110. Similarly, server 280 can communicate to docking station 110 via wireless telephone network 275 and mobile device 190.

Server 280 can include: (a) at least one processor 282; (b) a storage module 283; and (c) switching module 281 configured to run on processor 282 and be stored in storage module 283. Switching module 281 can be configured to facilitate switching a telephone call from being communicated over wireless telephone network 275 to wired network 270. Furthermore, switching module 281 can be configured to facilitate switching a telephone call from being communicated over wired network 270 to wireless telephone network 275.

“Server,” as used herein, can refer to a single computer, single server, or a cluster or collection of servers. Typically, a cluster or collection of servers can be used when the demands by client computers (e.g., docking station 110 and/or mobile device 190) are beyond the reasonable capability of a single server or computer. In many embodiments, the servers in the cluster or collection of servers are interchangeable from the perspective of the client computers.

Docking station module 220 can include: (a) a wired network module 221 configured to communicate with server 280 via wired network 270; (b) a wireless telephone network module 222 configured to communicate with server 280 via wireless telephone network 275 and cellular communications module 298; and (d) a transfer module 223 configured to facilitate transferring a telephone call from wireless telephone network 275 to wired network 270 when mobile device 190 is coupled to docking station 110. Transfer module 223 can be further configured to facilitate transferring a telephone call from wired network 270 to wireless telephone network 275 when or before mobile device 190 is uncoupled from docking station 110.

Electrical connector 211 and electrical connector 291 can be configured to be coupled together. In many examples, electrical connectors 211 and 291 can be USB (universal serial bus) connectors. For example, electrical connector 211 can be a male USB connector and electrical connector 291 can be a female USB electrical connector. In another example, electrical connectors 291 and 211 can be other types of electrical connectors such as thirty-pin dock connectors.

Electrical connector 213 can be configured to electrically and mechanically couple docking station 110 to wired network 270. For example, wired network can be a non-local data network (e.g., the Internet). In this example, a first connector of an Ethernet cable (not shown) can be coupled to electrical connector 213, and the other end can be coupled to a wall Ethernet socket coupled to the non-local network. In one embodiment, the Ethernet cable is a Category 5 (Cat 5) cable, and electrical connector 213 is RJ45 (registered jack) connectors. In the example where the wired network is a non-local data network such as the Internet, docking station 110 can be configured as a VOIP (Voice Over Internet Protocol) telephone or otherwise use the VOIP protocols to communicate the telephone call.

In other examples, wired network 270 can be other types of wired networks such as public switched telephone network (PSTN) or a private branch exchange (PBX), and electrical connector 213 can be, for example, a RJ11 socket.

In some embodiments, switch 212 can be coupled to electrical connectors 213 and 214 and processor 215. Switch 212 can be configured to communicate data received from wired network 270 to processor 215 (and other parts of docking station 110) and other electrical devices (e.g., a computer) coupled to electrical connector 214. In many buildings, a room will have only one Ethernet socket so if more than one electrical device needs to be coupled to the Ethernet socket, the electrical devices need to be daisy-chained together or coupled to a hub, which is coupled to the Ethernet socket.

In many examples, switch 212 can be an Ethernet switch and can communicate data from wired network 270 to other electrical devices coupled to electrical connectors 214. In many examples, electrical connectors 214 can be RJ45 connectors.

Processors 215 and 292 can be any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In some examples, storage module 216 and 293 can include memory and/or a hard drive. The memory can include both read only memory (ROM) and random access memory (RAM). Non-volatile portions of memory or the ROM can be encoded with a boot code sequence suitable for restoring docking station 110 to a functional state after a system reset.

Input mechanisms 219 can be configured to at least partially control docking station 110 and/or mobile device. In some examples, input mechanisms 219 can include buttons 108. For example, buttons 108 can be include buttons to allow a user to begin and end a telephone call, a numerical keypad, a speakerphone button, a headset button, a mute button, and a button that a user can push to indicate he desired to undock mobile device 190 from docking station 110.

The term “button” should be broadly understood to refer to any type of mechanism (with or without moving parts) whereby the user can input to docking station 110 his data signals, e.g., a mechanical pushbutton, an electrostatic pushbutton, an electrostatic array, or any other input device of any type. In other examples, docking station 110 does not include buttons 108, but instead includes a touch screen or another input mechanism.

Indication mechanism 209 can include one or more visual indications configured to provide information to the user. For example, docking station 110 can include one or more light emitting diodes (LEDs) or other visual indicators to notify the user when it is safe to uncouple mobile device 190 from docking station 110. In the same or different embodiments, indication mechanism 209 can include one or more audio indicators. For example, indication mechanism 209 can include one or more audio indicator to make a predetermined sound when a new telephone call is being received. In many embodiments, the audio indicators can be integrated with audio devices 218.

Audio devices 218 can include one or more devices configured to provide the incoming audio of the telephone call to the user and one or more devices configured to receive the incoming audio from the user. In the example shown in FIG. 1, audio devices 218 include a speaker and microphone 107.

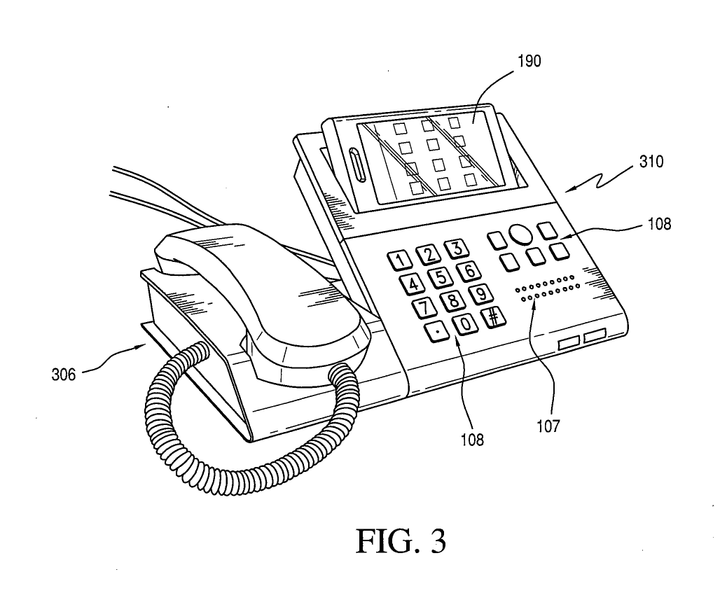

FIG. 3 illustrates a top, left side, front isometric view of a docking station 310 and mobile device 190, according to a second embodiment. In the embodiment shown in FIG. 3, docking station 310 can be similar to docking station 110 (FIG. 1), but can include: (a) speaker and microphone 107; and (b) a handset 306 configured to send and receive audio for the telephone call. Speaker and microphone 107 and handset 306 can be the audio devices of docking station 310.

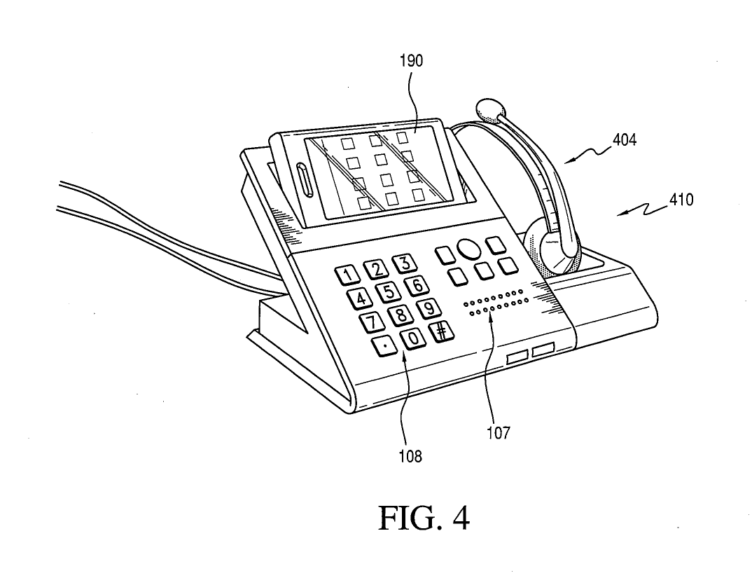

FIG. 4 illustrates a top, left side, front isometric view of a docking station 410 and mobile device 190, according to a third embodiment. In the embodiment shown in FIG. 4, docking station 410 can be similar to docking station 110 (FIG. 1), but can include: (a) speaker and microphone 107; and (b) telephone headset 404 configured to send and receive audio for the telephone call. Speaker and microphone 107 and telephone headset 404 can be the audio devices of docking station 410.

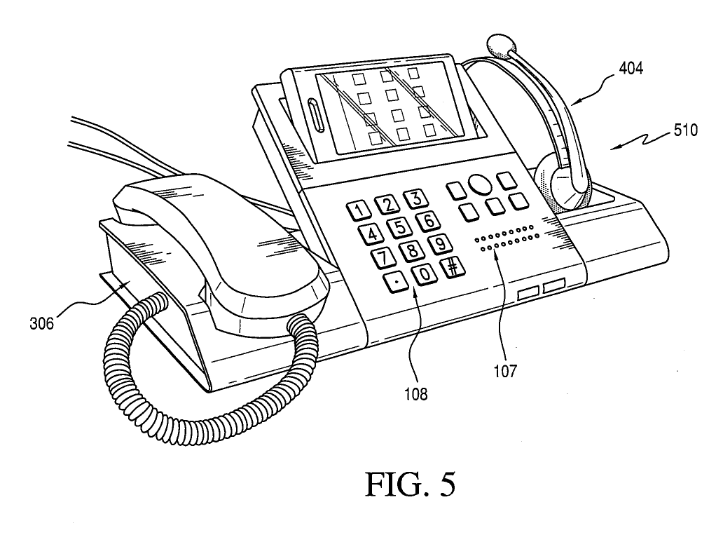

FIG. 5 illustrates a top, left side, front isometric view of docking station 510 and mobile device 190, according to a fourth embodiment. In the embodiment shown in FIG. 5, docking station 510 can include: (a) speaker and microphone 107; (b) handset 306; and (c) telephone headset 404. Speaker and microphone 107 and handset 306, telephone headset 404 can be the audio devices of docking station 510.

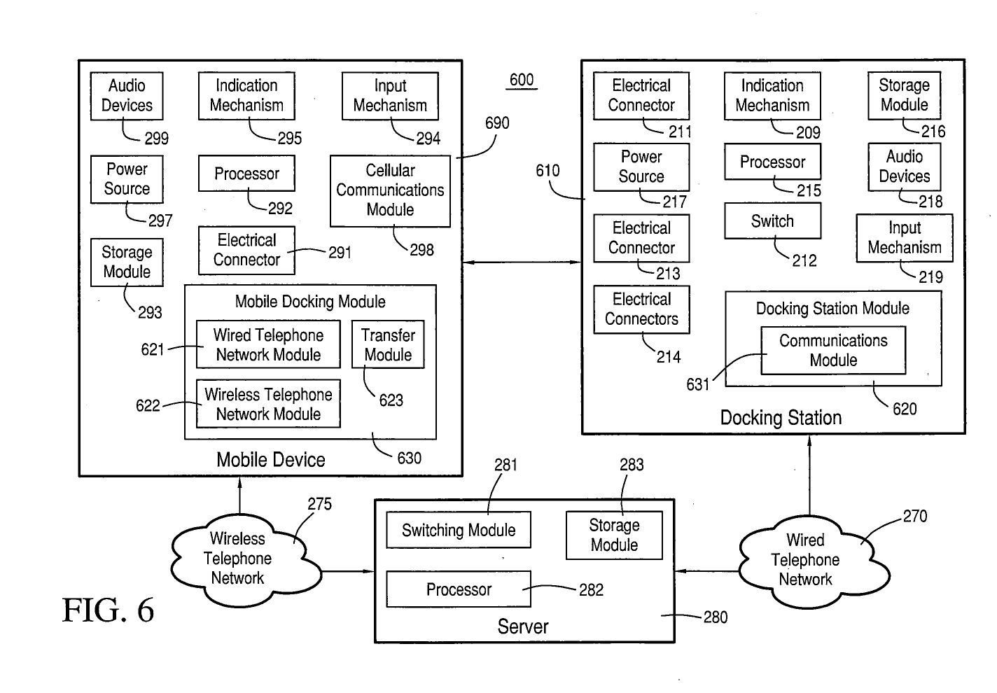

FIG. 6 illustrates a block diagram of a system 600 for placing and receiving telephone calls, according to a fifth embodiment. System 600 is merely exemplary and is not limited to the embodiments presented herein. System 600 can be employed in many different embodiments or examples not specifically depicted or described herein. In system 600, a mobile docking module 630 of mobile device 690 can control the telephone call transferring process instead of a docking station module 620 of docking station 610 controlling the telephone call transferring process.

In some embodiments, system 600 for placing and receiving telephone calls can include: (a) a docking station 610; (b) a mobile device 690; and (c) server 280 in communications with docking station 610 and mobile device 690 using wired network 270 and wireless telephone network 275, respectively. In different embodiments, system 600 can include docking station 610 and one or more software modules (e.g., mobile docking module 630 on mobile device 690), but not mobile device 690. In these examples, system 600 can include or not include server 280.

Docking station 610 can be configured to couple to mobile device 690 and can include: (a) an electrical connector 211 configured to couple to an electrical connector 291 of mobile device 290; (b) at least one switch 212 configured to communicate with wired network 270; (c) at least one electrical connector 213 coupled to switch 212 and configured to couple to wired network 270; (d) at least one electrical connector 214 coupled to switch 212 and configured to couple one or more other electrical devices to wired network 270 (via switch 212 and electrical connector 213); (e) at least one processor 215; (f) storage module 216; (g) one or more audio devices 218; (h) one or more input mechanisms 219 configured to receive input from a user of system 100; (i) docking station module 620 configured to run on processor 215 and be stored in storage module 216; (j) indication mechanism 209; and (j) power source 217 configured to provide electrical power for electrical connectors 211, 213, 214, switch 212, processor 215, storage module 216, audio devices 218, indication mechanism 209, and/or input mechanisms 219.

Mobile device 690 can be configured to couple to docking station 610 and can include: (a) electrical connector 291 configured to couple to electrical connector 211; (b) at least one processor 292; (c) storage module 293; (d) at least one input mechanism 294; (e) at least one indication mechanism 295; (f) mobile docking module 696 configured to run on processor 292 and be stored in storage module 293; (g) a cellular communications module 298 configured to communicate with wireless telephone network 275; (h) one or more audio devices 299; and (i) power source 297 configured to provide electrical power for electrical connectors 291, processor 292, storage module 293, input mechanisms 294, indication mechanisms 295 and/or audio devices 299.

Mobile docking module 630 can include: (a) a wired network module 621 configured to communicate with server 280 via wired network 270 and docking station 610; (b) a wireless telephone network module 622 configured to communicate with server 280 via wireless telephone network 275 and cellular communications module 298; and (d) a transfer module 623 configured to facilitate transferring a telephone call from wireless telephone network 275 to wired network 270 when mobile device 190 is coupled to docking station 110. Transfer module 623 can be further configured to facilitate transferring a telephone call from wired network 270 to wireless telephone network 275 when or before mobile device 190 is uncoupled from docking station 110.

Wired network module 621, wireless telephone network module 622, and transfer module 623 can have similar functionality to wired network module 221, wireless telephone network module 222, and transfer module 223, respectively, except that wired network module 692, wireless telephone network module 622, and transfer module 623 are configured to run on processor 292 and be stored in storage module 293, instead of running on processor 215 and being stored in storage module 216.

Docking station module 620 can include a communication module 631 configured to communicate with server 280 using wired network 270 and further configured to communicate with mobile docking module 630. Communication module 631 can be configured to facilitate communication using wired network 270 for wired network module 621 and transfer module 623.

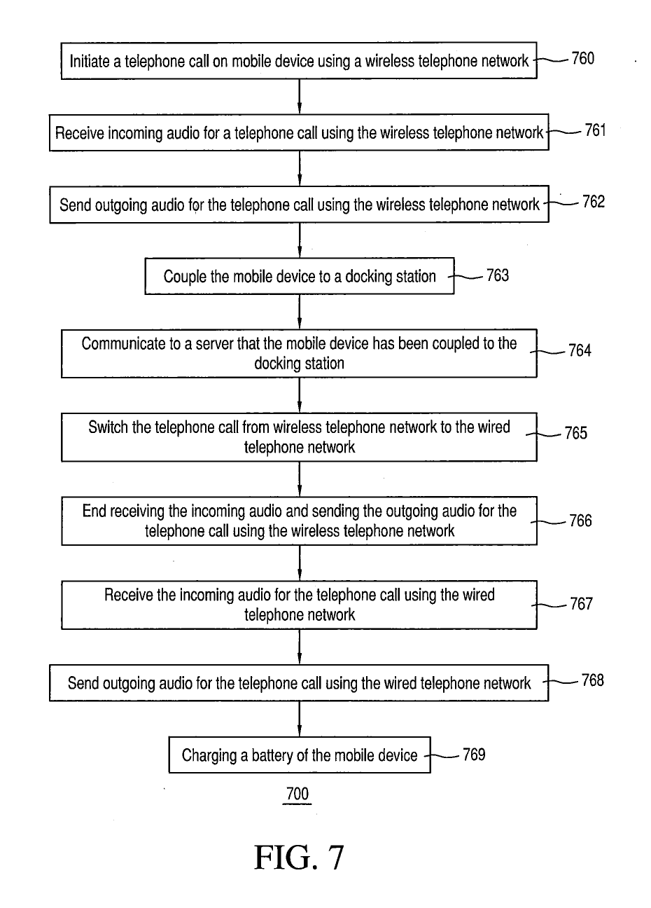

FIG. 7 illustrates a flow chart for an embodiment of a method 700 of placing and receiving telephone calls. Method 700 is merely exemplary and is not limited to the embodiments presented herein. Method 700 can be employed in many different embodiments or examples not specifically depicted or described herein. In some embodiments, the activities, the procedures, and/or the processes of method 700 can be performed in the order presented. In other embodiments, the activities, the procedures, and/or the processes of the method 700 can be performed in any other suitable order. In still other embodiments, one or more of the activities, the procedures, and/or the processes in method 700 can be combined or skipped.

Referring to FIG. 7, method 700 includes an activity 760 of initiating a telephone call using the wireless telephone network (e.g., a cellular telephone network). In some examples, a mobile device can receive a telephone call using the wireless telephone network. In other examples, the user of the mobile device can initiate a telephone call using the wireless telephone network. As an example, the mobile device and the wireless telephone network can be similar or identical to mobile device 190 or 690 of FIGS. 1 and 6 and wireless telephone network 275 of FIG. 2, respectively.

Method 700 in FIG. 7 continues with an activity 761 of receiving incoming audio for a telephone call on the mobile device using the wireless telephone network. In some examples, a cellular communications module in the mobile device can receive the incoming audio using the wireless telephone network. As an example, cellular telephone module can be similar or identical to cellular communications module 298 of FIG. 2.

Subsequently, method 700 of FIG. 7 includes an activity 762 of sending outgoing audio for the telephone call in the mobile device using the wireless telephone network. In some examples, a cellular communications module in the mobile device can send the outgoing audio using the wireless telephone network.

Next, method 700 of FIG. 7 includes an activity 763 of coupling the mobile device to a docking station. The mobile device can be coupled to the docking station while the mobile device is receiving incoming audio for the telephone call using a wireless telephone network and also while sending outgoing audio for the telephone call using the wireless telephone network. In some examples, an electrical connector of the mobile device can be coupled to an electrical connector of the docking station. As an example, the docking station, the electrical connector of the docking station, and the electrical connector of the mobile device can be similar or identical to docking station 110 or 610 of FIGS. 1 and 6, electrical connector 211 of FIG. 2, and electrical connector 291 of FIG. 2, respectively.

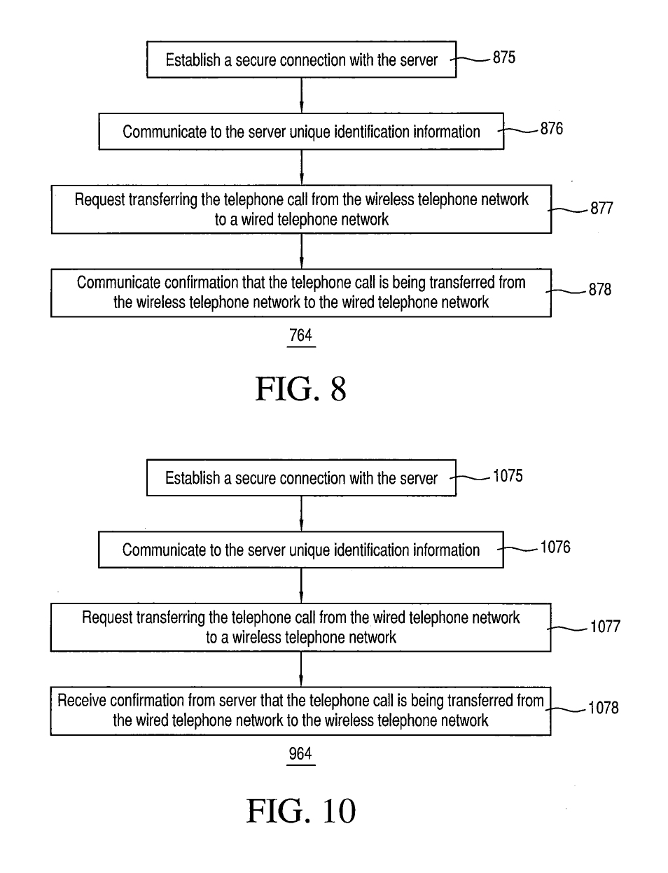

Method 700 in FIG. 7 continues with an activity 764 of communicating to a server that the mobile device has been coupled to the docking station. FIG. 8 illustrates a flow chart for an exemplary embodiment of activity 764 of communicating to a server that the mobile device has been coupled to the docking station.

Referring to FIG. 8, activity 764 includes a procedure 875 of establishing a secure connection with the server. In some examples, a transfer module of the docking station (or the mobile device) can establish a secure connection with a switching module of the server. In many embodiments, the transfer module and the switching module can undergo a handshaking routine and a process to set-up a secure connection between the docking station and the server. As an example, the transfer module and the switching module can be similar or identical to transfer module 223 or 623 of FIGS. 1 and 6 and switching module 281 of FIG. 2, respectively.

Activity 764 in FIG. 8 continues with a procedure 876 of communicating to the server unique identification information. In one example, the transfer module can communicate unique identification information of the mobile device (e.g., the telephone number of the mobile device) to the server. In other examples, the transfer module can communicate unique identification information of the docking station (e.g., MAC (media access control) address) to the server. In the same or different embodiments, unique identification information of both the mobile device and docking station are communicated to the server. The unique identification information can be communicated over the secure connection. The switching module can use the unique identification information to authenticate the identity of the mobile device and/or the docking station.

Subsequently, activity 764 of FIG. 8 includes a procedure 877 of requesting transferring the telephone call from the wireless telephone network to a wired network. In some examples, the transfer module can communicate the request to the switching module over the secure connection.

Next, activity 764 of FIG. 8 includes a procedure 878 of communicating confirmation that the telephone call is being transferred from the wireless telephone network to the wired network. In some examples, the switching module can communicate a confirmation that the telephone call is being transferred from the wireless telephone network to the wired network to the transfer module. After procedure 878, activity 764 is complete.

Referring again to FIG. 7, method 700 continues with an activity 765 of switching the telephone call from the wireless telephone network to the wired network. In some examples, the switching module can facilitate switching the telephone call to the wired network by facilitating starting the data for the telephone call being sent and received from the wired network to the docking station while the data for the telephone call is concurrently being sent to and received by the mobile device over the wireless telephone network.

Next, method 700 of FIG. 7 includes an activity 766 of ending receiving the incoming audio for the telephone call in the mobile device using the wireless telephone network. In some examples, when the wired network module of the docking station is receiving the data for the telephone call using the wired network, the wireless telephone networking module can communicate to the communications module of the mobile device to end receiving the incoming audio for the telephone call in the mobile device using the wireless telephone network. In particular, the cellular communications module of the mobile phone can end the wireless telephone network connection. Other examples have been described above. As an example, the wired network module and the wireless telephone network module can be similar or identical to wired network module 221 or 621 of FIGS. 2 and 6 and wireless telephone network module 222 and 622 of FIGS. 2 and 6, respectively.

Method 700 in FIG. 7 continues with an activity 767 of receiving the incoming audio for the telephone call using the wired network. In some examples, the wired network module can receive the incoming audio for the telephone call and send the incoming audio to the audio devices of the docking station and/or the mobile device. As an example, the audio devices can be similar or identical to audio devices 218 and/or 299 of FIG. 2. In many embodiments, receive incoming audio for the telephone call can be performed using a voice over IP (interne protocol) network connection where the voice over IP connection is made using the wired telephone connection.

Subsequently, method 700 of FIG. 7 includes an activity 768 of sending outgoing audio for the telephone call using the wired network. In some examples, the wired network module can receive the outgoing audio from the audio devices (e.g., audio devices 299 and/or audio devices 218 of FIG. 2) and send the outgoing audio for the telephone call to the wired network. In many embodiments, sending outgoing audio for the telephone call can be performed using a voice over IP network connection where the voice over IP connection is made using the wired telephone connection.

Next, method 700 of FIG. 7 includes an activity 769 of charging a power source of the mobile device while the mobile device is coupled to the docking station. In some examples, a power source (e.g., a battery) of the mobile device can be charged while the mobile device is coupled to the docking station and data for the telephone call is being transmitted using the wireless telephone network and/or the wired network. After activity 769, method 700 is complete.

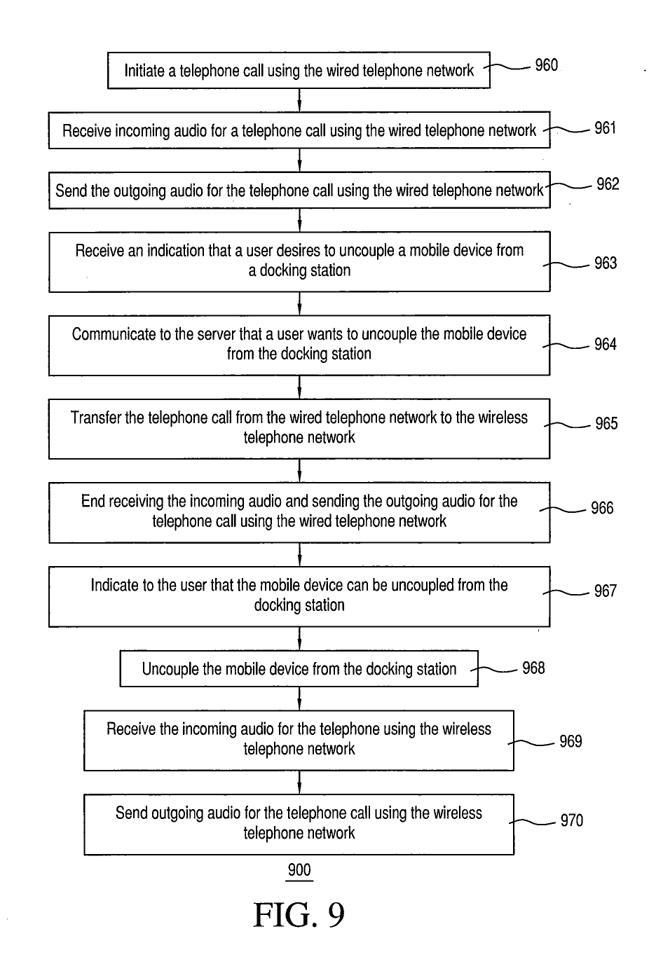

FIG. 9 illustrates a flow chart for an embodiment of a method 900 of placing and receiving telephone calls. Method 900 is merely exemplary and is not limited to the embodiments presented herein. Method 900 can be employed in many different embodiments or examples not specifically depicted or described herein. In some embodiments, the activities, the procedures, and/or the processes of method 900 can be performed in the order presented. In other embodiments, the activities, the procedures, and/or the processes of the method 900 can be performed in any other suitable order. In still other embodiments, one or more of the activities, the procedures, and/or the processes in method 900 can be combined or skipped.

Referring to FIG. 9, method 900 includes an activity 960 of initiating a telephone call using the wired network. In some examples, the docking station can receive a telephone call using the wired network. In other examples, the user of the docking station can initiate a telephone call using the wired network. As an example, the docking station and the wired network can be similar or identical to docking station 110 or 610 of FIGS. 1 and 6 and wired network 270 of FIG. 2, respectively.

Method 900 in FIG. 9 continues with an activity 961 of receiving incoming audio for a telephone call using the wired network. In some examples, a wired network module in the docking station can receive the incoming audio using the wired network. As an example, the wired network module can be similar or identical to wired network module 221 of FIG. 2. In many embodiments, receive incoming audio for the telephone call can be performed using a voice over IP network connection where the voice over IP connection is made using the wired telephone connection.

Subsequently, method 900 of FIG. 9 includes an activity 962 of sending the outgoing audio for the telephone call using the wired network. In some examples, the wired network module in the docking station can send the outgoing audio using the wired network. In many embodiments, sending outgoing audio for the telephone call can be performed using a voice over IP network connection where the voice over IP connection is made using the wired telephone connection.

Next, method 900 of FIG. 9 includes an activity 963 of receiving an indication that a user desires to uncouple the mobile device from the docking station. In many embodiments, the indication is received while receiving the incoming audio (or sending the outgoing audio) for the telephone call using a wired network. For example, the user can use one of an input mechanism on the docking station or an input mechanism on the mobile device to indicate the desire to uncouple the mobile device from the docking station. As an example, the input mechanism of the docking station and the input mechanism of the mobile device can be similar or identical to input mechanisms 219 of FIG. 2 and input mechanisms 294 of FIG. 2, respectively.

Subsequently, method 900 of FIG. 9 includes an activity 964 of communicating to a server that a user wants to uncouple the mobile device from the docking station. As an example, the server can be similar to server 280 of FIG. 2. FIG. 10 illustrates a flow chart for an exemplary embodiment of activity 964 of communicate to the server that a user wants to uncouple the mobile device from the docking station.

Referring to FIG. 10, activity 964 includes a procedure 1075 of establishing a secure connection with the server. In some examples, a transfer module of the docking station (or the mobile device) can establish a secure connector with a switching module of the server. In many embodiments, the transfer module and the switching module can undergo a handshaking routine and a process to set-up a secure connector between the docking station and the server. As an example, the transfer module and the switching module can be similar or identical to transfer module 223 or 623 of FIGS. 1 and 6 and switching module 281 of FIG. 2, respectively.

Activity 964 in FIG. 10 continues with a procedure 1076 of communicating to the server unique identification information. In one example, the transfer module can communicate unique identification information of the mobile device (e.g., the telephone number of the mobile device) to the server. In other examples, the transfer module can communicate unique identification information of the docking station (e.g., MAC address) to the server. In the same or different embodiments, unique identification information of both the mobile device and docking station are communicated to the server. The unique identification information can be communicated over the secure connection. The switching module can use the unique identification information to authenticate the identity of the mobile device and/or the docking station.

Subsequently, activity 964 of FIG. 9 includes a procedure 1077 of requesting transferring the telephone call from the wired network to a wireless telephone network. In some examples, the transfer module can communicate the request to the switching module over the secure connection.

Next, activity 964 of FIG. 9 includes a procedure 1078 of receiving confirmation from the server that the telephone call is being transferred from the wireless telephone network to the wired network. In some examples, the switching module can communicate a confirmation that the telephone call is being transferred from the wireless telephone network to the wired network. After procedure 1078, activity 964 is complete.

Referring again to FIG. 9, method 900 of FIG. 9 includes an activity 965 of transferring the telephone call from the wired network to the wireless telephone network. In some examples, the switching module can facilitate switching of the telephone call to the wireless telephone network by facilitating sending and receiving of the data for the telephone call over the wireless telephone network while the data for the telephone call is concurrently being sent to and received from the mobile device over the wireless telephone network.

Method 900 in FIG. 9 continues with an activity 966 of ending the receiving the incoming audio and sending the outgoing audio for the telephone call via the wired network. In some examples, when the cellular communications module of the mobile device is receiving the data for the telephone call using the wireless telephone network, the wired networking module can communicate to the server to stop sending the incoming audio for the telephone call using the wired network. As an example, wired network module can be similar or identical to wired network module 221 or 621 of FIGS. 1 and 6, respectively.

Subsequently, method 900 of FIG. 9 includes an activity 967 of indicating to the user that the mobile device can be uncoupled from the docking station. In some embodiments, an indication mechanism of the docking station or an indication mechanism of the mobile device can providing a visual indication to the user that the mobile device can be uncoupled from the docking station. As an example, the indication mechanism of the docking station and the indication mechanism of the mobile device can be similar or identical to indication mechanism 209 of FIG. 2 and indication mechanism 295 of FIG. 2, respectively.

Next, method 900 of FIG. 9 includes an activity 968 of uncoupling the mobile device from the docking station. In some examples, the user can uncouple an electrical connector of mobile device 190 from an electrical connector of the docking station. As an example, the electrical connector of the docking station and the electrical connector of the mobile device can be similar or identical to electrical connector 211 of FIG. 2, and electrical connector 291 of FIG. 2, respectively.

Method 900 in FIG. 9 continues with an activity 969 of receiving the incoming audio for the telephone call in the mobile device using the wireless telephone network. In some examples, the cellular communications module can receive the incoming audio for the telephone call using the wireless telephone network and send the incoming audio to the audio devices of the mobile device. As an example, audio devices can be similar or identical to audio devices 299 of FIG. 2.

Subsequently, method 900 of FIG. 9 includes an activity 970 of sending outgoing audio for the telephone call using the mobile device and the wireless telephone network. In some examples, the cellular communications module can receive the outgoing audio from the audio devices and send the outgoing audio for the telephone call to the wireless telephone network.

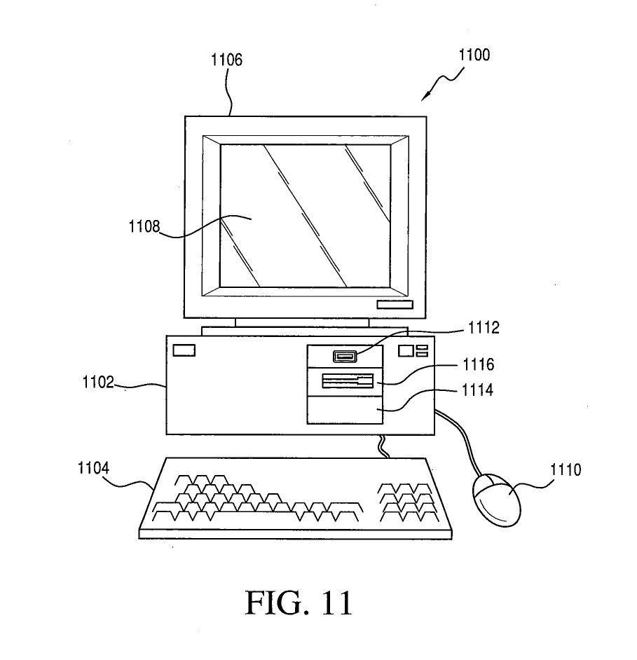

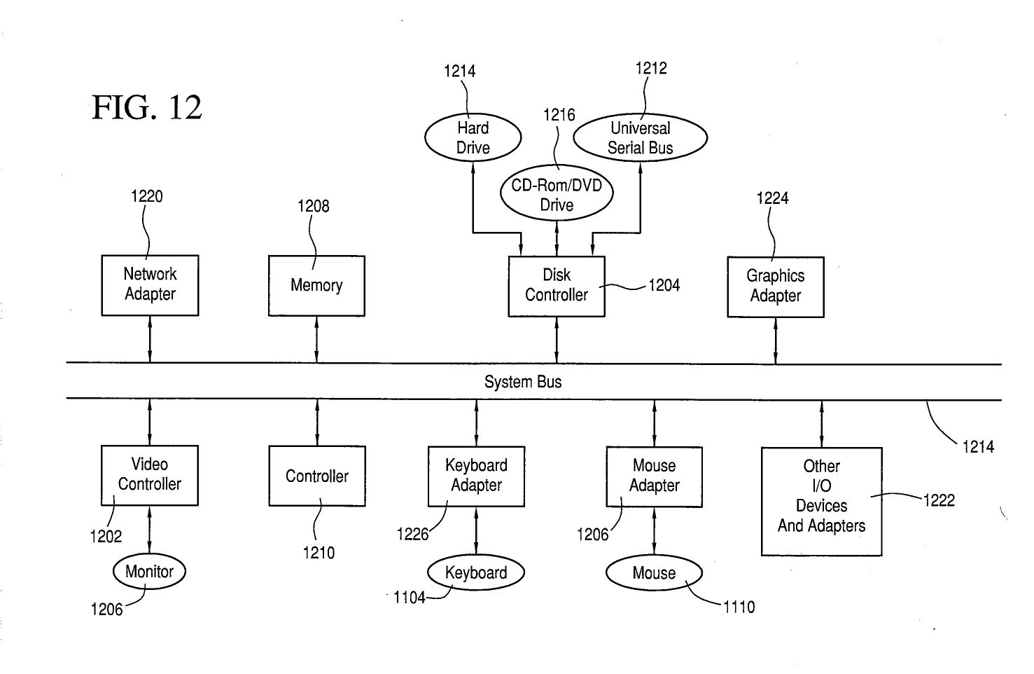

FIG. 11 illustrates a computer 1100 that is suitable for implementing an embodiment of at least a portion of server 280 (FIG. 2). Computer 1100 includes a chassis 1102 containing one or more circuit boards (not shown), a USB (universal serial bus) port 1112, a Compact Disc Read-Only Memory (CD-ROM) and/or Digital Video Disc (DVD) drive 1116, and a hard drive 1114. A representative block diagram of the elements included on the circuit boards inside chassis 1102 is shown in FIG. 12. A central processing unit (CPU) 1210 in FIG. 12 is coupled to a system bus 1214 in FIG. 12. In various embodiments, the architecture of CPU 1210 can be compliant with any of a variety of commercially distributed architecture families.

System bus 1214 also is coupled to memory 1208 that includes both read only memory (ROM) and random access memory (RAM). Non-volatile portions of memory 1208 or the ROM can be encoded with a boot code sequence suitable for restoring computer 1100 (FIG. 11) to a functional state after a system reset. In addition, memory 1208 can include microcode such as a Basic Input-Output System (BIOS). In some examples, storage module 283 can include memory 1208, floppy drive 1112, hard drive 1114, and/or CD-ROM or DVD drive 1116.

In the depicted embodiment of FIG. 12, various I/O devices such as a disk controller 1204, a graphics adapter 1224, a video controller 1202, a keyboard adapter 1226, a mouse adapter 1206, a network adapter 1220, and other I/O devices 1222 can be coupled to system bus 1214. Keyboard adapter 1226 and mouse adapter 1206 are coupled to a keyboard 1104 (FIGS. 11 and 12) and a mouse 1110 (FIGS. 11 and 12), respectively, of computer 1100 (FIG. 11). While graphics adapter 1224 and video controller 1202 are indicated as distinct units in FIG. 12, video controller 1202 can be integrated into graphics adapter 1224, or vice versa in other embodiments. Video controller 1202 is suitable for refreshing a monitor 1106 (FIGS. 11 and 12) to display images on a screen 1108 (FIG. 11) of computer 1100 (FIG. 11). Disk controller 1204 can control hard drive 1114 (FIGS. 11 and 12), floppy disc drive 1112 (FIGS. 11 and 12), and CD-ROM or DVD drive 1116 (FIGS. 11 and 12). In other embodiments, distinct units can be used to control each of these devices separately.

Although many other components of computer 1100 (FIGS. 11 and 12) are not shown, such components and their interconnection are well known to those of ordinary skill in the art. Accordingly, further details concerning the construction and composition of computer 1100 and the circuit boards inside chassis 1102 (FIG. 11) need not be discussed herein.

When computer 1100 in FIG. 11 is running, program instructions stored on stored on a USB drive in USB port 1112, on a CD-ROM or DVD in CD-ROM and/or DVD drive 1116, on hard drive 1114, or in memory 1208 (FIG. 12) are executed by CPU 1210 (FIG. 12). A portion of the program instructions, stored on these devices, can be suitable for carrying out a portion of method 700 or 900 (FIGS. 2 and 9, respectively) as described previously with respect to FIGS. 1-10.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 760-769 of FIG. 7, procedures 875-878 of FIG. 8, activities 960-970 of FIG. 9, and procedures 1075-1078 of FIG. 10 may be comprised of many different activities, procedures and be performed by many different modules, in many different orders that any element of FIG. 1 may be modified and that the foregoing discussion of certain of these embodiments does not necessarily represent a complete description of all possible embodiments. As another example, activity 769 (FIG. 7) can be part of method 900 (FIG. 9).

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of placing and receiving a telephone call, the method comprising:
determining that a mobile device has been coupled to a docking station while audio for the telephone call is communicated using the mobile device and a wireless telephone network;
communicating to a server that the mobile device has been coupled to the docking station;
requesting that the server facilitate transfer of the telephone call from the wireless telephone network to a wired network;
receiving incoming audio for the telephone call using the docking station and the wired network; and
sending outgoing audio for the telephone call using the docking station and the wired network,
wherein:
the audio for the telephone call comprises the incoming audio and the outgoing audio.

2. The method of claim 1, further comprising:
receiving the incoming audio for the telephone call using the mobile device and the wireless telephone network before determining that the mobile device has been coupled to the docking station; and
sending the outgoing audio for the telephone call using the mobile device and the wireless telephone network before determining that the mobile device has been coupled to the docking station.

3. The method of claim 2, further comprising:
ending receiving the incoming audio for the telephone call using the mobile device and the wireless telephone network after receiving the incoming audio for the telephone call using the docking station and the wired network; and
ending sending the outgoing audio for the telephone call using the mobile device and the wireless telephone network after sending the outgoing audio for the telephone call using the docking station and the wired network.

4. The method of any one of claim 1, further comprising:
receiving a first indication that a user wants to uncouple the mobile device from the docking station while receiving the incoming audio for the telephone call using the docking station and the wired network;
communicating to the server that the user desires to uncouple the mobile device from the docking station;
receiving the incoming audio for the telephone call using the mobile device and the wireless telephone network;
indicating to the user that the mobile device can be uncoupled from the docking station;
after the mobile device has been uncoupled from the docking station, ending receiving the incoming audio for the telephone call using the docking station and the wired network; and
after the mobile device is uncoupled from the docking station, ending sending the outgoing audio for the telephone call using the docking station and the wired network.

5. The method of claim 4, wherein:
indicating to the user that the mobile device can be uncoupled from the docking station comprises:
providing a visual indication to the user that the mobile device can be uncoupled from the docking station.

6. The method of any one of claim 1, wherein:
receiving the incoming audio for the telephone call using the docking station and the wired network comprises:
receiving the incoming audio for the telephone call in the docking station using a voice over internet protocol network connection;
sending the outgoing audio for the telephone call using the docking station and the wired network comprises:
sending the outgoing audio for the telephone call from the docking station using the voice over internet protocol network connection; and
the voice over internet protocol connection is made using the wired network.

7. The method of any one of claim 1, wherein:
communicating to the server comprises:
establishing a secure connection with the server; and
communicating to the server over the secure connection unique identification information for at least one of the mobile device or the docking station.

8. The method of any one of claim 1, wherein:
the wireless telephone network comprises a cellular telephone network.

9. The method of any one of claim 1, further comprising:
charging a battery of the mobile device while the mobile device is coupled to the docking station.

10. The method of any one of claim 1, further comprising:
using the server to facilitate switching the telephone call from the wireless telephone network to the wired network.

11. A system for placing and receiving a telephone call, the system comprising:
a docking station configured to couple to a mobile device, the docking station comprising:
at least one processor;
an electrical connector configured to couple to the mobile device;
a switch configured to couple to a wired network;
one or more input mechanisms configured to receive input from a user;
one or more visual indications configured to provide information to the user;
a docking station module configured run on the at least one processor, the docking station module comprising:
a wired network module configured to communicate data for the telephone call over the wired network; and
a transfer module configured to transfer the telephone call from a wireless telephone network to the wired network when or after the mobile device is coupled to the electrical connector of the docking station.

12. The system of claim 11, wherein:
the transfer module is further configured to transfer the telephone call from the wired network to the wireless telephone network when or before the mobile device is uncoupled from the electrical connector of the docking station.

13. The system of claim 11, wherein:
the switch comprises an Ethernet switch.

14. The system of any one of claim 11, wherein:
the docking station further comprises:
one or more audio devices configured to receive outgoing audio for the telephone call and communicate incoming audio for the telephone call to the user of the docking station.

15. The system of any one of claim 11, wherein:
the docking station further comprises:
a handset or a headset configured to receive and send audio for the telephone call.

16. A method of placing and receiving a telephone call, the method comprising:
receiving incoming audio for the telephone call using a wired network and a docking station when a mobile device is coupled to the docking station;
sending outgoing audio for the telephone call using the wired network and the docking station when the mobile device is coupled to the docking station;
receiving an indication that a user desires to uncouple the mobile device from the docking station;
communicating to a server to switch the telephone call from the wired network to a wireless telephone network;
receiving the incoming audio for the telephone call in the mobile device using the wireless telephone network;
sending the outgoing audio for the telephone call in the mobile device using the wireless telephone network;
ending receiving the incoming audio and sending the outgoing audio for the telephone call via the wired network and the docking station; and
indicating to the user that the mobile device can be uncoupled from the docking station.

17. The method of claim 16, wherein:
communicating to the server comprises:
establishing a secure connection with the server; and
communicating to the server over the secure connection unique identification information for at least one of the mobile device or the docking station.

18. The method of claim 16, wherein:
the wireless telephone network comprises a cellular telephone network.

19. The method of any one of claim 16, wherein:
receiving the incoming audio for the telephone call using the wired network comprises:
receiving the incoming audio for the telephone call in the docking station using a voice over internet protocol network connection;
sending the outgoing audio for the telephone call using the wired network comprises:
sending the outgoing audio for the telephone call from the docking station using the voice over internet protocol network connection; and
the voice over internet protocol connection is made using the wired network.

20. The method of any one of claim 16, further comprising:
charging a battery of the mobile device while the mobile device is coupled to the docking station.
